(19) United States
(12) Patent Application Publication
(10) Pub. No.: US 2026/0371272 A1
(43) Pub. Date: Nov. 19, 2026

(54) ENHANCING SMALL DATA TRANSMISSIONS FOR REDUCED CAPABILITY USER EQUIPMENT

(71) Applicant: Apple Inc., Cupertino, CA (US)

(72) Inventors: Jie Cui, San Jose, CA (US); Chunxuan Ye, San Diego, CA (US); Dawei Zhang, Saratoga, CA (US); Haitong Sun, Saratoga, CA (US); Hong He, San Jose, CA (US); Qiming Li, Beijing (CN); Rolando E. Bettancourt Ortega, Munich (DE); Xiang Chen, Campbell, CA (US); Yang Tang, San Jose, CA (US)

(21) Appl. No.: 19/155,308

(22) PCT Filed: Feb. 17, 2023
(86) PCT No.: PCT/CN2023/076853

§ 371 Date: Aug. 11, 2025

(51) Int. Cl. H04W 56/00; H04B 17/318; H04W 68/02; H04W 76/27; H04W 76/28

(52) U.S. Cl. CPC H04W 56/0045; H04B 17/328; H04W 68/02; H04W 76/27; H04W 76/28

(57) ABSTRACT

Disclosed are methods, systems, and computer-readable medium to perform operations including: identifying a first resource for a small data transmission (SDT) to a base station, determining that the first resource for the SDT is outside a first paging time window (PTW), and in response to determining that the first resource for the SDT is outside the first PTW, transmitting the SDT using a second resource that is in a second PTW different from the first PTW.

### BACKGROUND

Wireless communication networks provide integrated communication platforms and telecommunication services to wireless user devices. Example telecommunication services include telephony, data (e.g., voice, audio, and/or video data), messaging, internet-access, and/or other services. The wireless communication networks have wireless access nodes that exchange wireless signals with the wireless user devices using wireless network protocols, such as protocols described in various telecommunication standards promulgated by the Third Generation Partnership Project (3GPP). Example wireless communication networks include code division multiple access (CDMA) networks, time division multiple access (TDMA) networks, frequency-division multiple access (FDMA) networks, orthogonal frequency-division multiple access (OFDMA) networks, Long Term Evolution (LTE), and Fifth Generation New Radio (5G NR). The wireless communication networks facilitate mobile broadband service using technologies such as OFDM, multiple input multiple output (MIMO), advanced channel coding, massive MIMO, beamforming, and/or other features.

Initially, the 5G NR wireless communication standards aimed to support three main use cases: enhanced mobile broadband (eMBB), ultra-reliable and low-latency communication (URLLC), and massive machine-type communication (mMTC). Over time, several 5G NR use cases have emerged whose requirements differ from those of eMBB, URLLC, and mMTC. To support these emerging use cases more efficiently, the 3GPP has expanded the 5G NR wireless communication standards to include a new class of reduced capability (RedCap) user equipment (UE). These RedCap UEs have relatively low cost, complexity, and/or power consumption, and thus are better suited for use cases such as industrial sensors, video surveillance, and wearables.

### SUMMARY

The techniques described here enhance small data transmission (SDT) for UEs (e.g., RedCap UEs) by enabling support of a paging time window (PTW) during the SDT procedure. Specifically, the techniques described here enable a UE to either delay or continue an SDT that would occur outside the PTW window. For instance, in some examples, a UE can delay an SDT that would occur outside the PTW to a subsequent PTW in order to maintain a low-power sleep state outside the PTWs. In some examples, the UE and the network can coordinate to continue the SDT that would occur outside the PTW by extending or disabling the PTW, thereby decreasing latency of the SDT. The described techniques also enable the UE to reuse some or all of the results from timing advance (TA) validation and synchronization in certain scenarios to further increase efficiency.

In general, in an aspect, a method to be performed by a UE includes identifying a first resource for a SDT to a base station, determining that the first resource for the SDT is outside a first PTW, and in response to determining that the first resource for the SDT is outside the first PTW, transmitting the SDT using a second resource that is in a second PTW different from the first PTW

In some examples, the method includes performing at least one of a TA validation procedure or synchronization procedure with the base station in the first PTW, and using results from the at least one of the TA validation procedure or synchronization procedure for transmission of the SDT to the base station via the second resource that is in the second PTW.

In some examples, the method includes performing at least one of a TA validation procedure or synchronization procedure with the base station in the first PTW, and reperforming the at least one of the TA validation procedure or synchronization procedure with the base station in the second PTW.

In some examples, the method includes performing a first reference signal received power (RSRP) measurement in the first PTW, performing a second RSRP measurement in the second PTW, and performing TA validation with the base station based on the first RSRP measurement and the second RSRP measurement. In some examples, the first RSRP measurement and the second RSRP measurement are performed within a time threshold.

In some examples, the method includes performing a first RSRP measurement in the first PTW, reperforming the first RSRP measurement in the second PTW, performing a second RSRP measurement in the second PTW, and performing TA validation with the base station based on the reperformed first RSRP measurement and the second RSRP measurement.

In some examples, the UE is a RedCap UE in a radio resource control inactive (RRC_INACTIVE) state. In some examples, the first PTW is in a first extended discontinuous reception (eDRX) cycle, and the second PTW is in a second eDRX cycle different from the first eDRX cycle. In some examples, the first and second eDRX cycles are greater than 10.24 seconds.

In general, in an aspect, a method to be performed by a base station includes transmitting a first reference signal to a UE during a first PTW, determining that the UE is transmitting an SDT in a second PTW that is different from the first PTW, and retransmitting the first reference signal to the UE during the second PTW.

In some examples, the method includes transmitting a second reference signal to the UE during the second PTW. In some examples, the method includes receiving, from the UE, the SDT during the second PTW.

In some examples, the first reference signal is transmitted as part of a TA validation procedure. In some examples, the UE is a RedCap UE in an RRC INACTIVE state. In some examples, the first PTW is within a first eDRX cycle, and the second PTW is in a second eDRX cycle different from the first eDRX cycle. In some examples, the first and second eDRX cycles are greater than 10.24 seconds.

In general, in an aspect, a method to be performed by a UE includes identifying a resource for transmission of an SDT to a base station, wherein the resource is inside or outside a PTW, determining that the PTW is to be extended or disabled, and in response to the determination, continuing transmission of the SDT using the resource.

In some examples, the method includes determining that the resource for the SDT is outside the PTW, in response to determining that the resource for the SDT is outside the PTW, transmitting, to the base station, a request to extend or disable the PTW, and receiving, from the base station, an indication that the PTW is to be extended or disabled in response to the request.

In some examples, the method includes performing at least a portion of a TA validation procedure or a synchronization procedure with the base station in the PTW, in response to performing at least the portion of the TA validation procedure or the synchronization procedure, transmitting, to the base station, a request to extend or disable the PTW, and receiving, from the base station, an indication that the PTW is to be extended or disabled in response to the request.

In some examples, the method includes receiving a reference signal from the base station during the PTW, and determining that the PTW is to be extended or disabled based on a timing of the reference signal.

In some examples, the method includes determining that the PTW is to be extended or disabled in response to the base station scheduling the resource for the SDT outside the PTW.

In some examples, the method includes transmitting, to the base station, at least one SDT in the PTW, and determining that the PTW is to be extended or disabled in response to transmission of the at least one SDT in the PTW.

In some examples, the PTW is to be extended or disabled for a predefined time. In some examples, the method includes receiving, from the base station, an indication of a time for which the PTW is to be extended or disabled. In some examples, the method includes receiving, from the base station, data configured to set a timer for which the PTW is to be extended or disabled. In some examples, the method includes disabling the PTW, receiving, from the base station, an indication to enable the PTW, and enabling the PTW in response to the indication.

In some examples, the UE is a RedCap UE in an RRC_INACTIVE state. In some examples, the PTW is within an eDRX cycle. In some examples, the eDRX cycle is greater than 10.24 seconds.

In general, in an aspect, a method to be performed by a base station, includes monitoring for an SDT by a UE during a PTW, determining that the PTW is to be extended or disabled, and in response to the determination, continuing monitoring for the SDT by the UE.

In some examples, the method includes receiving, from the UE, a request for the PTW to be extended or disabled, and in response to the request, transmitting, to the UE, an indication that the PTW is to be extended or disabled.

In some examples, the method includes determining that the PTW is to be extended or disabled based on a scheduling of at least one resource for the SDT.

In some examples, the method includes determining that the PTW is to be extended or disabled based on a timing of a reference signal transmitted to the UE during the PTW.

In some examples, the method includes determining that the PTW is to be extended or disabled based on a scheduling of a resource for the SDT outside the PTW.

In some examples, the method includes receiving, from the UE, at least one SDT during the PTW, and determining that the PTW is to be extended or disabled in response to receipt of the at least one SDT during the PTW.

In some examples, the PTW is to be extended or disabled for a predefined time. In some examples, the method includes transmitting, to the UE, an indication of a time for which the PTW is to be extended or disabled. In some examples, the method includes transmitting, to the UE, data configured to set a timer for which the PTW is to be extended or disabled. In some examples, the method includes transmitting, to the UE, an indication to enable the PTW.

In some examples, the UE is a RedCap UE in an RRC INACTIVE state. In some examples, the PTW is within an eDRX cycle. In some examples, the eDRX cycle is greater than 10.24 seconds.

In general, in an aspect, a system includes one or more processors and one or more storage devices storing instructions which, when executed by the one or more processors, cause the one or more processors to perform the foregoing method(s).

In general, in an aspect, a non-transitory computer-readable storage medium stores instructions which, when executed by one or more processors, cause the one or more processors to perform the foregoing method(s).

In general, in an aspect, an apparatus includes one or more baseband processors configured to perform the foregoing method(s).

The details of one or more embodiments of these systems and methods are set forth in the accompanying drawings and the description below. Other features, objects, and advantages of these systems and methods will be apparent from the description and drawings, and from the claims.

### BRIEF DESCRIPTION OF THE FIGURES

FIG. 1 illustrates a wireless network, according to some implementations.

FIGS. 2A-2C illustrate examples of delaying SDT outside the PTW, according to some implementations.

FIGS. 3A-3C illustrate examples of continuing SDT outside the PTW, according to some implementations.

FIGS. 4-7 illustrate flowcharts of example methods, according to some implementations.

FIG. 8 illustrates a user equipment (UE), according to some implementations.

FIG. 9 illustrates an access node, according to some implementations.

### DETAILED DESCRIPTION

In Release 17 of the 5G NR wireless communications standards, a framework for RedCap UEs was introduced to support use cases that benefit from UEs having relatively low cost, complexity, and/or power consumption. As part of this framework, a small data transmission (SDT) procedure was defined for RedCap UEs operating in an extended discontinuous reception (eDRX) mode.

In general, SDT is a procedure that enables a UE (e.g., a RedCap UE) to transmit small data payloads in a radio resource control inactive (RRC_INACTIVE) state, thereby avoiding the overhead of transitioning to an RRC_CONNECTED state. The SDT procedure for RedCap UEs can be broken into two stages: SDT initialization and subsequent SDT. During SDT initialization, a UE determines whether: (1) the amount of uplink data to be transmitted is less than or equal to the SDT data threshold; (2) the downlink reference signal received power (RSRP) is greater than or equal to the configured SDT RSRP threshold; and (3) a valid SDT resource is available (e.g., a SDT random access (SDT-RA) resource or a SDT configured grant (SDT-CG) resource). If each of these criteria is satisfied, then the UE can initiate the SDT procedure via transmission over the SDT-RA or SDT-CG resource. However, before SDT transmission, the UE performs timing advance (TA) validation and synchronization, such as described in 3GPP Technical Specification (TS) 38.133:

### 5.2B.2 Requirements on UE Synchronization for Small Data Transmissions for RedCap

The requirements in this clause are applicable for the UE performing small data transmissions using configured resources as [TS 38.331].

The UE is allowed to transmit using the configured uplink resources provided that the UE is synchronized towards (i.e., using the timing derived using the latest available N_{TA} value as specified in subclause 7.1.2) the serving cell prior to transmission. If the UE is not able to obtain the synchronization towards the serving cell then the UE shall drop the small data transmission. The UE determines the small data transmission occasion according to the received CG-SDT configuration [TS 38.331].

### 5.2B.2.1 TA validation Requirements for RedCap

When cg-SDT-RSRP-ChangeThreshold [TS 38.331] is configured for TA validation based on the RSRP change criterion according to clause 5.8.2.x in [TS 38.321], the UE is allowed to transmit using CG-SDT using the timing derived using the latest available NTA value as specified in subclause 7.1 provided that
the first RSRP (RSRP₁) measurement and the second RSRP (RSRP₂) measurements used in the TA validation are valid measurements and,
timing alignment validation for transmission using CG-SDT is valid according to the validation criteria in clause 5.8.2 in [TS 38.321].

RSRP₁ and RSRP₂ are considered valid provided that the conditions in Table 5.2B.2-1 are met for FR1. RSRP₁ and RSRP₂ are considered valid provided that the conditions in Table 5.2B.2-2 are met for FR2.

After the initial SDT, subsequent transmissions are handled differently depending on the type of resource used to initiate the SDT procedure. When using CG resources, the network (e.g., base station) can schedule subsequent uplink transmissions using dynamic grants, or they can take place on the following CG resource occasion(s). The UE can initiate subsequent uplink transmission after reception of confirmation of the initial transmission from the network. When using RA resources, the network can schedule subsequent uplink transmissions using dynamic uplink grants and/or assignments after completion of the RA procedure.

When defining the foregoing SDT procedure in Release 17 of the 5G NR standards, it was agreed that, for a RedCap UE in an RRC_INACTIVE state, the eDRX cycle would not exceed 10.24 seconds, and a paging time window (PTW) (e.g., a time window during the eDRX cycle in which the UE is in a deep sleep and does not send/receive data, and in which the network does not monitor signals from the UE) would not be used. However, in Release 18, an eDRX cycle greater than 10.24 seconds has been proposed to increase power savings by RedCap UEs in the RRC INACTIVE state. In this scenario, a PTW would be used during the eDRX cycle, which could create conflicts with the SDT procedure.

The techniques described here enhance SDT for UEs (e.g., RedCap UEs) by enabling support of a PTW during the SDT procedure. Specifically, the techniques described here enable a UE to either delay or continue an SDT that would occur outside the PTW window. For instance, in some examples, a UE can delay an SDT that would occur outside the PTW to a subsequent PTW in order to maintain a low-power sleep state outside the PTWs. In some examples, the UE and the network can coordinate to continue the SDT that would occur outside the PTW by extending or disabling the PTW, thereby decreasing latency of the SDT. The techniques described here also enable the UE to reuse some or all of the results from TA validation and synchronization in certain scenarios to further increase efficiency.

While aspects may be described herein in the context of SDT by RedCap UEs, aspects of the present disclosure can also be applied to SDT by other types of UEs.

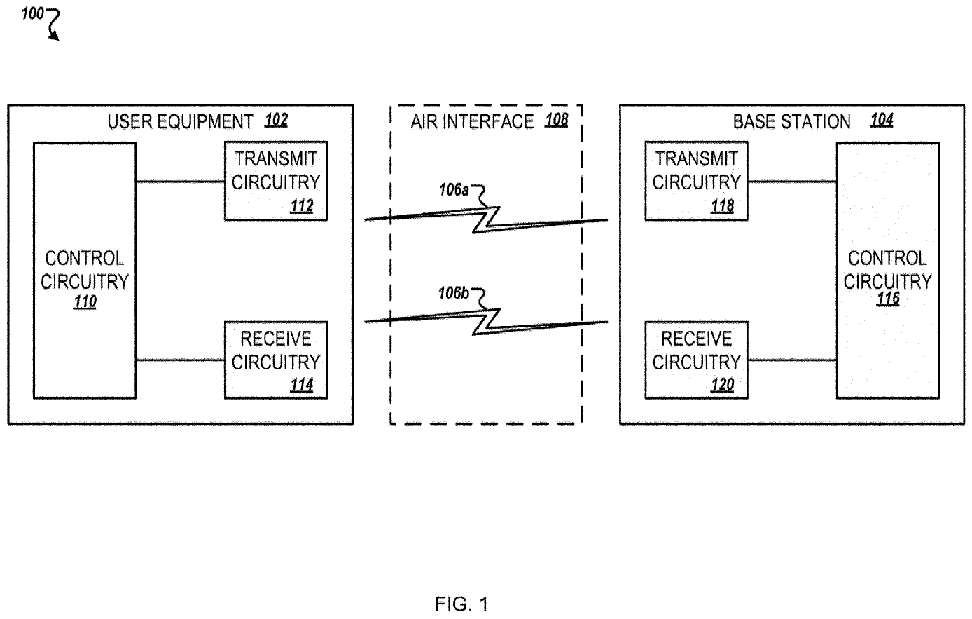

FIG. 1 illustrates a wireless network 100, according to some implementations. The wireless network 100 includes a UE 102 and a base station 104 connected via one or more channels 106A, 106B across an air interface 108. The UE 102 and base station 104 communicate using a system that supports controls for managing the access of the UE 102 to a network via the base station 104.

In some implementations, the wireless network 100 may be a Non-Standalone (NSA) network that incorporates Long Term Evolution (LTE) and Fifth Generation (5G) New Radio (NR) communication standards as defined by the Third Generation Partnership Project (3GPP) technical specifications. For example, the wireless network 100 may be a E-UTRA (Evolved Universal Terrestrial Radio Access)-NR Dual Connectivity (EN-DC) network, or a NR-EUTRA Dual Connectivity (NE-DC) network. However, the wireless network 100 may also be a Standalone (SA) network that incorporates only 5G NR. Furthermore, other types of communication standards are possible, including future 3GPP systems (e.g., Sixth Generation (6G)) systems, Institute of Electrical and Electronics Engineers (IEEE) 802.11 technology (e.g., IEEE 802.11a; IEEE 802.11b; IEEE 802.11g; IEEE 802.11-2007; IEEE 802.11n; IEEE 802.11-2012; IEEE 802.11ac; or other present or future developed IEEE 802.11 technologies), IEEE 802.16 protocols (e.g., WMAN, WiMAX, etc.), or the like. While aspects may be described herein using terminology commonly associated with 5G NR, aspects of the present disclosure can be applied to other systems, such as 3G, 4G, and/or systems subsequent to 5G (e.g., 6G).

In the wireless network 100, the UE 102 and any other UE in the system may be, for example, laptop computers, smartphones, tablet computers, machine-type devices such as smart meters or specialized devices for healthcare, intelligent transportation systems, or any other wireless devices with or without a user interface. In network 100, the base station 104 provides the UE 102 network connectivity to a broader network (not shown). This UE 102 connectivity is provided via the air interface 108 in a base station service area provided by the base station 104. In some implementations, such a broader network may be a wide area network operated by a cellular network provider, or may be the Internet. Each base station service area associated with the base station 104 is supported by antennas integrated with the base station 104. The service areas are divided into a number of sectors associated with certain antennas. Such sectors may be physically associated with fixed antennas or may be assigned to a physical area with tunable antennas or antenna settings adjustable in a beamforming process used to direct a signal to a particular sector.

The UE 102 includes control circuitry 110 coupled with transmit circuitry 112 and receive circuitry 114. The transmit circuitry 112 and receive circuitry 114 may each be coupled with one or more antennas. The control circuitry 110 may include various combinations of application-specific circuitry and baseband circuitry. The transmit circuitry 112 and receive circuitry 114 may be adapted to transmit and receive data, respectively, and may include radio frequency (RF) circuitry or front-end module (FEM) circuitry.

In various implementations, aspects of the transmit circuitry 112, receive circuitry 114, and control circuitry 110 may be integrated in various ways to implement the operations described herein. The control circuitry 110 may be adapted or configured to perform various operations such as those described elsewhere in this disclosure related to a UE. For instance, the control circuitry 110 can carry out TA validation and synchronization procedures, and perform operations to delay or continue SDT outside of a PTW, among other operations.

The transmit circuitry 112 can perform various operations described in this specification. For example, the transmit circuitry 112 can transmit SDT and related. Additionally, the transmit circuitry 112 may transmit a plurality of multiplexed uplink physical channels. The plurality of uplink physical channels may be multiplexed according to time division multiplexing (TDM) or frequency division multiplexing (FDM) along with carrier aggregation. The transmit circuitry 112 may be configured to receive block data from the control circuitry 110 for transmission across the air interface 108.

The receive circuitry 114 can perform various operations described in this specification. For instance, the receive circuitry 114 can receive information from the network (e.g., base station) regarding extensions to or disablement of a PTW. Additionally, the receive circuitry 114 may receive a plurality of multiplexed downlink physical channels from the air interface 108 and relay the physical channels to the control circuitry 110. The plurality of downlink physical channels may be multiplexed according to TDM or FDM along with carrier aggregation. The transmit circuitry 112 and the receive circuitry 114 may transmit and receive both control data and content data (e.g., messages, images, video, etc.) structured within data blocks that are carried by the physical channels.

FIG. 1 also illustrates the base station 104. In implementations, the base station 104 may be an NG radio access network (RAN) or a 5G RAN, an E-UTRAN, a non-terrestrial cell, or a legacy RAN, such as a UTRAN or GERAN. As used herein, the term “NG RAN” or the like may refer to the base station 104 that operates in an NR or 5G wireless network 100, and the term “E-UTRAN” or the like may refer to a base station 104 that operates in an LTE or 4G wireless network 100. The UE 102 utilizes connections (or channels) 106A, 106B, each of which includes a physical communications interface or layer.

The base station 104 circuitry may include control circuitry 116 coupled with transmit circuitry 118 and receive circuitry 120. The transmit circuitry 118 and receive circuitry 120 may each be coupled with one or more antennas that may be used to enable communications via the air interface 108. The transmit circuitry 118 and receive circuitry 120 may be adapted to transmit and receive data, respectively, to any UE connected to the base station 104. The transmit circuitry 118 may transmit downlink physical channels includes of a plurality of downlink subframes. The receive circuitry 120 may receive a plurality of uplink physical channels from various UEs, including the UE 102.

In FIG. 1, the one or more channels 106A, 106B are illustrated as an air interface to enable communicative coupling, and can be consistent with cellular communications protocols, such as a GSM protocol, a CDMA network protocol, a UMTS protocol, a 3GPP LTE protocol, an Advanced long term evolution (LTE-A) protocol, a LTE-based access to unlicensed spectrum (LTE-U), a 5G protocol, a NR protocol, an NR-based access to unlicensed spectrum (NR-U) protocol, and/or any of the other communications protocols discussed herein. In implementations, the UE 102 may directly exchange communication data via a ProSe interface. The ProSe interface may alternatively be referred to as a sidelink (SL) interface and may include one or more logical channels, including but not limited to a Physical Sidelink Control Channel (PSCCH), a Physical Sidelink Control Channel (PSCCH), a Physical Sidelink Discovery Channel (PSDCH), and a Physical Sidelink Broadcast Channel (PSBCH).

As noted above, in Release 18 of the 5G NR standards, an eDRX cycle greater than 10.24 seconds that utilizes a PTW has been proposed to increase power savings by RedCap UEs in the RRC INACTIVE state. However, this change could cause problems during the SDT procedure for RedCap UEs. For instance, the 5G NR standards do not define how the network and UE are to handle an SDT that falls outside the PTW. In addition, the standards do not specify how to address situations in which the UE completed some or all of the TA validation and/or synchronization procedures, but has not transmitted the SDT.

In accordance with an aspect of the present disclosure, for both CG-SDT and RA-SDT, the UE can delay (or mute) an SDT outside the PTW until the next available resource (e.g., SDT occasion) in the following PTW. In such a case, the UE can remain in a deep sleep outside the PTW, and the network need only monitor for/receive SDT from the UE during the PTW. In some examples, the UE can delay the SDT even though some or all of the TA validation and/or synchronization procedures were completed during the PTW.

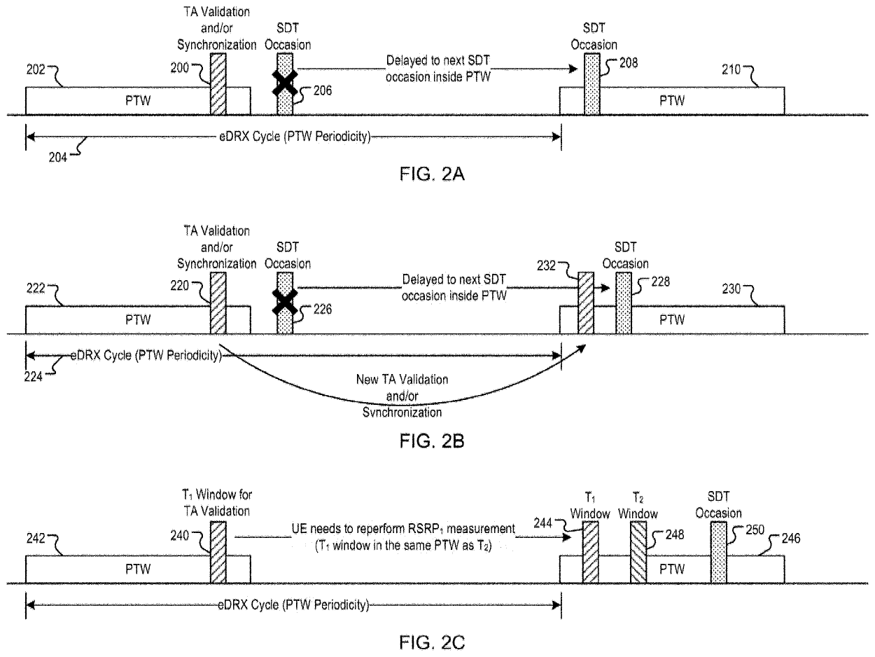

For example, referring to FIG. 2A, a UE completed TA validation and/or synchronization 200 during PTW 202 in eDRX cycle 204. Although the UE is otherwise prepared to initiate SDT, it determines that the next SDT occasion 206 is outside the PTW 202. Accordingly, the UE remains in a deep sleep and delays the SDT to the next SDT occasion 208 in the following PTW 210. In this example, since the UE has already completed TA validation and/or synchronization 200 during PTW 202, it can leverage the results from these procedures to transmit the SDT during the SDT occasion 208 without reperforming TA validation and/or synchronization in PTW 210.

FIG. 2B illustrates another example of delaying SDT outside the PTW window. Similar to the example in FIG. 2A, the UE has completed TA validation and/or synchronization 220 during PTW 222 in eDRX cycle 224, but delays the SDT to the next SDT occasion 228 in the following PTW 230 because the initial SDT occasion 226 is outside the PTW 222. However, unlike FIG. 2A, the UE reperforms TA validation and/or synchronization 232 before transmission of the SDT in PTW 230. While reperforming TA validation and/or synchronization results in the consumption of additional resources, it may be preferred in some situations, such as where the eDTX cycle 224 is long, to avoid interference and ensure integrity of the SDT.

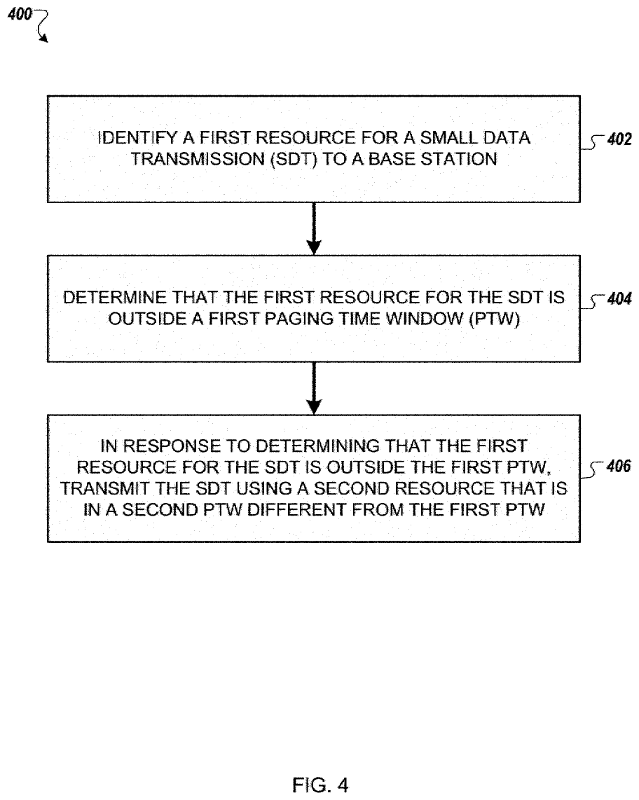

In some examples, the UE may only have an opportunity to perform part of the TA validation (and/or synchronization) during the initial PTW. For instance, the UE may perform the RSRP₁ measurement for TA validation during a T₁ window 240 in PTW 242, but may not have an opportunity to perform the RSRP₂ measurement due to expiration of the PTW 242 before the T₂ window, as shown in FIG. 4C. In accordance with an aspect of the present disclosure, the UE may reperform the RSRP₁ measurement during a T₁ window 244 in PTW 246, and perform (for the first time) the RSRP₂ measurement during a T₂ window 248 in the PTW 246, before transmission of the SDT at the SDT occasion 250. In this manner, the UE ensures that both the RSRP₁ measurement/T₁ window and RSRP₂ measurement/T₂ window are contained in the same PTW. Alternatively, it may be defined (e.g., in the 5G NR standards) that the UE only needs to ensure that the RSRP₁ measurement/T₁ window and RSRP₂ measurement/T₂ window are within a particular time threshold, such as in the same PTW or in two successive PTWs.

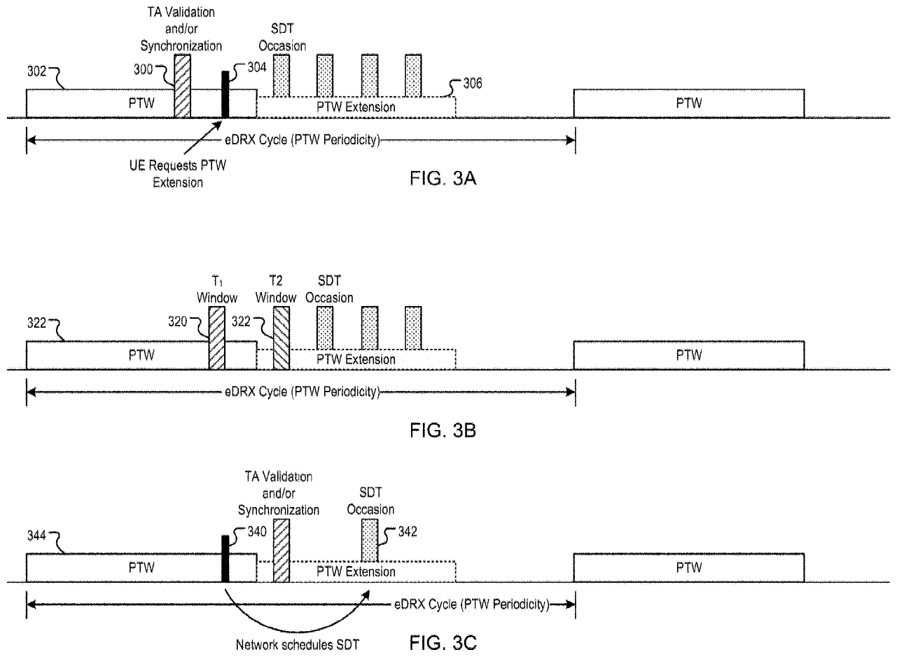

In accordance with an aspect of the present disclosure, the UE and network may coordinate to continue transmission of an SDT outside the PTW by, for example, extending the PTW or temporarily disabling the PTW. For instance, referring to FIG. 3A, when the UE completes TA validation and/or synchronization 300 within a PTW 302, the UE can send an indication 304 for the network to extend the PTW 302, thereby producing a PTW window extension 306 within which the UE can transmit the SDT(s). Alternatively, the indication 304 can request that the network temporarily disable the PTW 302 so that the UE can transmit the SDT(s).

In general, extending the PTW could be implemented by extending the PTW for a predefined time (e.g., predefined in the 5G NR standards), or a time configured by the network (e.g., through higher layer signaling). In some examples, the network can configure the UE with a timer, and the PTW can be extended until the timer expires. In some examples, disabling the PTW could be implemented by the network indicating to the UE to disable the PTW, and later indicating to the UE to enable the PTW.

As another example, the PTW can be extended or disabled when the UE completes part of the TA validation, as shown in FIG. 3B. In this example, the UE completes the RSRP₁ measurement during the T₁ window 320 in PTW 322, but is unable to complete the remaining RSRP₂ measurement before the PTW 322 expires. Since the network knows the timing of the T₁ window 320, the network can automatically extend the PTW 322 or disable the PTW to allow time for the UE to perform the RSRP₂ measurement during the T₂ window 324 and complete TA validation.

FIG. 3C illustrates another example of continuing SDT outside the PTW, in accordance with an aspect of the present disclosure. In this example, the network schedules 340 an SDT during an SDT occasion 342 outside the PTW 344. Since this SDT is based on network scheduling, the network can automatically extend (or disable) the PTW 344 to cover the scheduled SDT occasion 342 in order to provide the UE with sufficient time to perform TA validation and/or synchronization and complete transmission of the SDT.

In some examples, if a UE transmits at least one SDT inside a PTW, the PTW after that SDT is ignored by the UE and the network, and the network will continuously monitor for the subsequent SDT from the UE as long as those SDT occasions belongs to the same SDT session (e.g., same RRC SDT configuration).

In some examples, as long as the network configures an SDT to a UE, the PTW is ignored by the UE and the network until network releases the SDT configuration.

FIG. 4 illustrates a flowchart of an example method 400, according to some implementations. For clarity of presentation, the description that follows generally describes method 400 in the context of the other figures in this description. For example, method 400 can be performed by UE 102 of FIG. 1. It will be understood that method 400 can be performed, for example, by any suitable system, environment, software, hardware, or a combination of systems, environments, software, and hardware, as appropriate. In some implementations, various steps of method 400 can be run in parallel, in combination, in loops, or in any order.

Operations of the method 400 include identifying a first resource transmission of a SDT to a base station (402). For example, a UE (e.g., the UE 102 of FIG. 1) can identify an uplink resource, such as an SDT-RA or SDT-CG resource, that has been configured or is otherwise available for transmission of the SDT to the base station (e.g., the base station 104 of FIG. 1). In some examples, the UE is a RedCap UE as defined in the 3GPP 5G NR standards. In some examples, the UE (e.g., the RedCap UE) is in an RRC_INACTIVE state.

At 404, it is determined that the first resource for the SDT is outside a first PTW. In response, the SDT is transmitted using a second resource that is in a second PTW different from the first PTW. For example, the first PTW can be in a first eDRX cycle, and the second PTW can be in a second eDRX cycle different from the first eDRX cycle. In some examples, the first and second eDRX cycles are greater than 10.24 seconds.

In some examples, the method 400 includes performing, by the UE, at least one of a TA validation procedure or synchronization procedure with the base station in the first PTW. In some examples, results from the at least one of the TA validation procedure or synchronization procedure are used for transmission of the SDT to the base station via the second resource that is in the second PTW. In some examples, the UE reperforms the at least one of the TA validation procedure or synchronization procedure with the base station in the second PTW.

In some examples, the method 400 includes performing, by the UE, a first RSRP measurement in the first PTW, performing a second RSRP measurement in the second PTW, and performing TA validation with the base station based on the first RSRP measurement and the second RSRP measurement. In some examples, the first RSRP measurement and the second RSRP measurement are performed within a time threshold, such as a predefined (e.g., in the 3GPP standards) or preconfigured (e.g., by the network) time threshold.

In some examples, the method 400 includes performing, by the UE, a first RSRP measurement in the first PTW, reperforming the first RSRP measurement in the second PTW, performing a second RSRP measurement in the second PTW, and performing TA validation with the base station based on the reperformed first RSRP measurement and the second RSRP measurement.

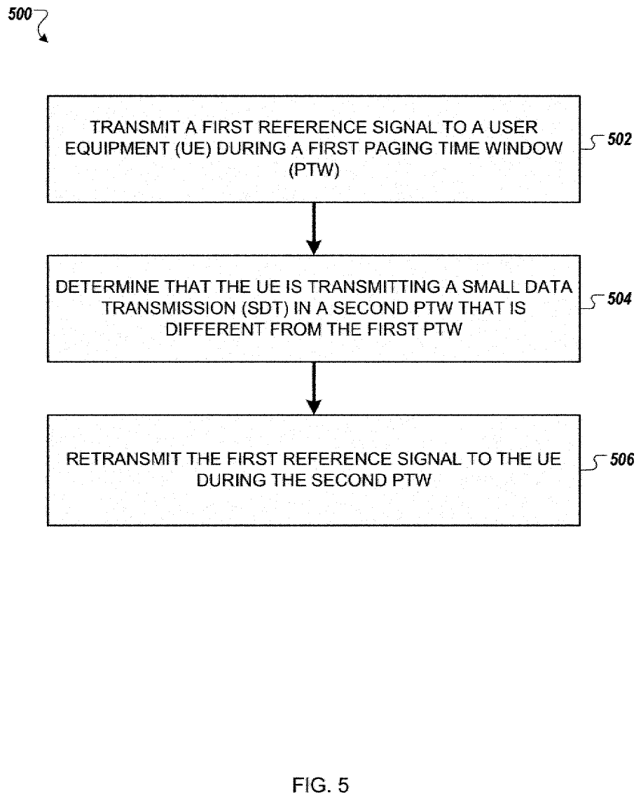

FIG. 5 illustrates a flowchart of an example method 500, according to some implementations. For clarity of presentation, the description that follows generally describes method 500 in the context of the other figures in this description. For example, method 500 can be performed by the base station 104 of FIG. 1. It will be understood that method 500 can be performed, for example, by any suitable system, environment, software, hardware, or a combination of systems, environments, software, and hardware, as appropriate. In some implementations, various steps of method 500 can be run in parallel, in combination, in loops, or in any order.

Operations of the method 500 include transmitting a first reference signal to a UE during a first PTW (502). For example, a base station (e.g., the base station 104 of FIG. 1) can transmit a first reference signal to the UE (e.g., the UE 102 of FIG. 1) during a first PTW so that the UE can perform TA validation and/or synchronization with the base station in order to transmit an SDT. In some examples, the UE is a RedCap UE as defined in the 3GPP 5G NR standards. In some examples, the UE (e.g., the RedCap UE) is in an RRC_INACTIVE state.

At 504, it is determined that the UE is transmitting an SDT in a second PTW that is different from the first PTW. For example, the UE can indicate to the base station that the SDT is not being transmitted in the first PTW and/or is being delayed to the second PTW, or the base station can infer that the SDT is not being transmitted in the first PTW and/or is being delayed to the second PTW based on, for example, not receiving the SDT during the first PTW, timing of the transmission of the first reference signal, or the like. In some examples, the first PTW is in a first eDRX cycle, and the second PTW is in a second eDRX cycle different from the first eDRX cycle. In some examples, the first and second eDRX cycles are greater than 10.24 seconds.

In response to determining that the UE is transmitting the SDT in a second PTW, the base station retransmits the first reference signal to the UE during the second PTW (506). In some examples, the base station also transmits a second reference signal to the UE during the second PTW. In some examples, the method 500 includes receiving, from the UE and by the base station, the SDT during the second PTW.

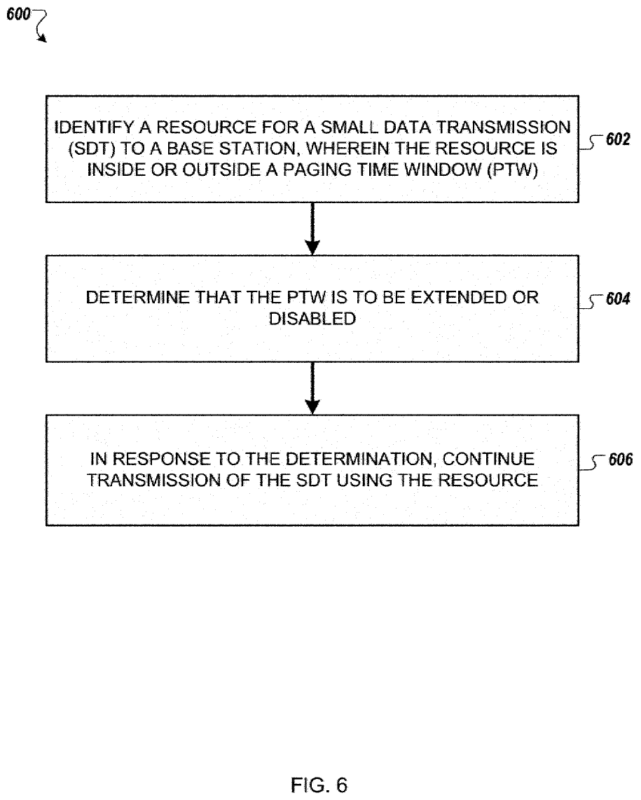

FIG. 6 illustrates a flowchart of an example method 600, according to some implementations. For clarity of presentation, the description that follows generally describes method 600 in the context of the other figures in this description. For example, method 600 can be performed by the UE 102 of FIG. 1. It will be understood that method 600 can be performed, for example, by any suitable system, environment, software, hardware, or a combination of systems, environments, software, and hardware, as appropriate. In some implementations, various steps of method 600 can be run in parallel, in combination, in loops, or in any order.

Operations of the method 600 include identifying a resource for transmission of an SDT to a base station, in which the resource is inside or outside a PTW (602). For example, a UE (e.g., the UE 102 of FIG. 1) can identify an uplink resource, such as an SDT-RA or SDT-CG resource, that has been configured or is otherwise available for transmission of the SDT to the base station (e.g., the base station 104 of FIG. 1). In some examples, the UE is a RedCap UE as defined in the 3GPP 5G NR standards. In some examples, the UE (e.g., the RedCap UE) is in an RRC_INACTIVE state.

At 604, it is determined by the UE that the PTW is to be extended or disabled. For instance, in some examples, the UE determines that the resource for the SDT is outside the PTW and, in response, transmits, a request to the base station to extend or disable the PTW. The UE then receives, from the base station, an indication that the PTW is to be extended or disabled in response to the request. In some examples, the UE performs at least a portion of a TA validation procedure or a synchronization procedure with the base station in the PTW and, in response, transmits a request to the base station to extend or disable the PTW. The UE then receives, from the base station an indication that the PTW is to be extended or disabled in response to the request. In some examples, the UE receives a reference signal from the base station during the PTW and determines that the PTW is to be extended or disabled based on a timing of the reference signal. In some examples, the UE determines that the PTW is to be extended or disabled in response to the base station scheduling the resource for the SDT outside the PTW. In some examples, the UE transmits at least one SDT to the base station in the PTW, and determines that the PTW is to be extended or disabled in response to transmission of the at least one SDT in the PTW. In response to the determination that the PTW is to be extended or disabled, the UE continues transmission of the SDT using the resource (606).

In some examples, the PTW is to be extended or disabled for a predefined time. In some examples, the UE receives, from the base station, an indication of a time for which the PTW is to be extended or disabled. In some examples, the UE receives, from the base station, data configured to set a timer for which the PTW is to be extended or disabled. In some examples, the UE and/or base station disables the PTW, the UE receives, from the base station, an indication to enable the PTW, and the UE enables the PTW in response to the indication.

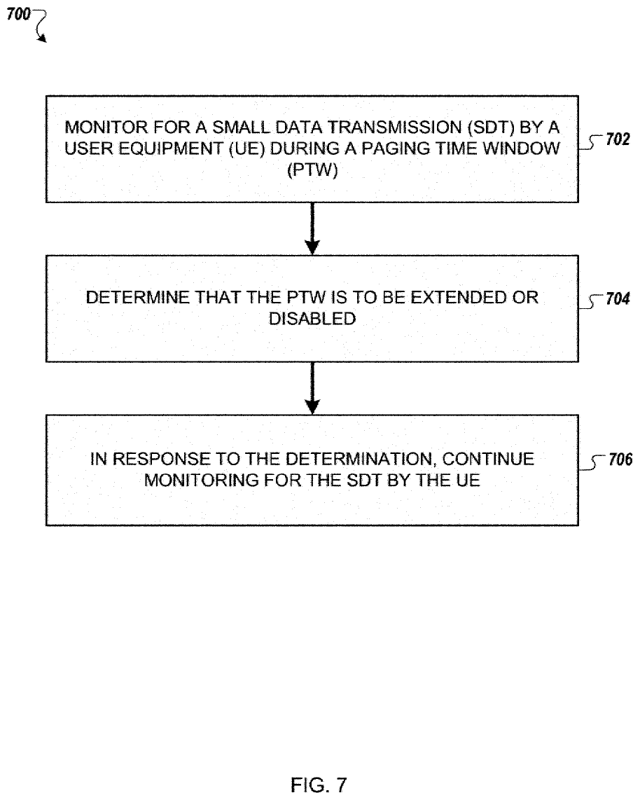

FIG. 7 illustrates a flowchart of an example method 700, according to some implementations. For clarity of presentation, the description that follows generally describes method 700 in the context of the other figures in this description. For example, method 700 can be performed by the base station 104 of FIG. 1. It will be understood that method 700 can be performed, for example, by any suitable system, environment, software, hardware, or a combination of systems, environments, software, and hardware, as appropriate. In some implementations, various steps of method 700 can be run in parallel, in combination, in loops, or in any order.

Operations of the method 700 include monitoring for an SDT by a UE during a PTW (702). For example, a base station (e.g., the base station 104 of FIG. 1) can monitor for an SDT by the UE (e.g., the UE 102 of FIG. 1) during an eDRX cycle having a PTW. In some examples, the UE is a RedCap UE as defined in the 3GPP 5G NR standards. In some examples, the UE (e.g., the RedCap UE) is in an RRC_INACTIVE state.

At 704, it is determined by the base station that the PTW is to be extended or disabled. For instance, in some examples, the base station receives, from the UE, a request for the PTW to be extended or disabled, and, in response, transmits an indication to the UE that the PTW is to be extended or disabled. In some examples, the base station determines that the PTW is to be extended or disabled based on a scheduling of at least one resource for the SDT. In some examples, the base station determines that the PTW is to be extended or disabled based on a timing of a reference signal transmitted to the UE during the PTW. In some examples, the base station determines that the PTW is to be extended or disabled based on a scheduling of a resource for the SDT outside the PTW. In some examples, the base station receives at least one SDT from the UE during the PTW, and determines that the PTW is to be extended or disabled in response to receipt of the at least one SDT during the PTW. In response to the determination that the PTW is to be extended or disabled, the base station continues to monitor for the SDT by the UE (e.g., outside the PTW) (706).

In some examples, the PTW is to be extended or disabled for a predefined time. In some examples, the base station transmits, to the UE, an indication of a time for which the PTW is to be extended or disabled. In some examples, the base station transmits, to the UE, data configured to set a timer for which the PTW is to be extended or disabled. In some examples, the base station transmits, to the UE, an indication to enable the PTW (e.g., after the PTW has been disabled).

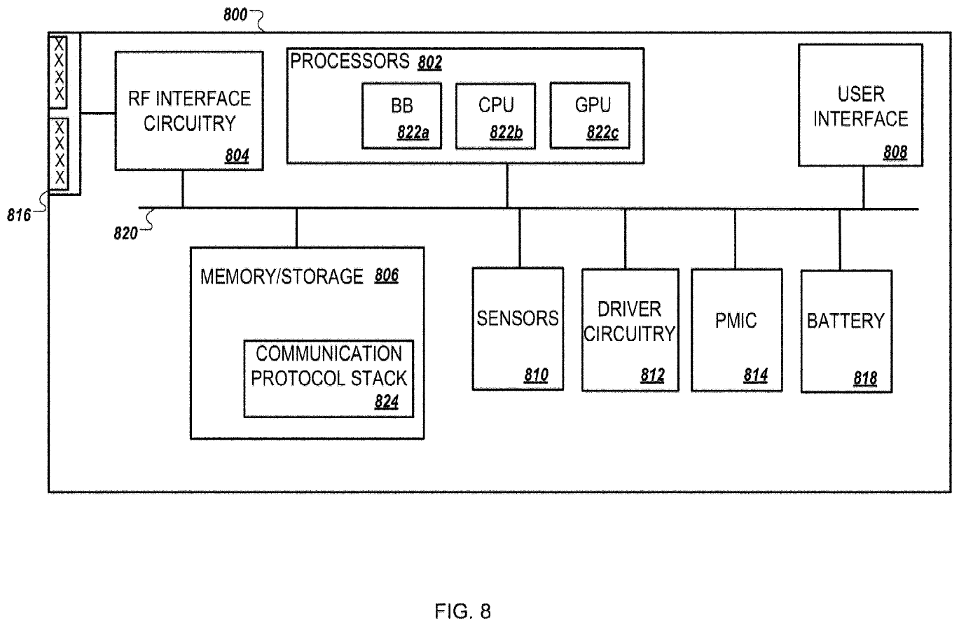

FIG. 8 illustrates a UE 800, according to some implementations. The UE 800 may be similar to and substantially interchangeable with UE 102 of FIG. 1.

The UE 800 may be any mobile or non-mobile computing device, such as, for example, mobile phones, computers, tablets, industrial wireless sensors (for example, microphones, pressure sensors, thermometers, motion sensors, accelerometers, inventory sensors, electric voltage/current meters, etc.), video devices (for example, cameras, video cameras, etc.), wearable devices (for example, a smart watch), relaxed-IoT devices.

The UE 800 may include processors 802, RF interface circuitry 804, memory/storage 806, user interface 808, sensors 810, driver circuitry 812, power management integrated circuit (PMIC) 814, antenna structure 816, and battery 818. The components of the UE 800 may be implemented as integrated circuits (ICs), portions thereof, discrete electronic devices, or other modules, logic, hardware, software, firmware, or a combination thereof. The block diagram of FIG. 8 is intended to show a high-level view of some of the components of the UE 800. However, some of the components shown may be omitted, additional components may be present, and different arrangement of the components shown may occur in other implementations.

The components of the UE 800 may be coupled with various other components over one or more interconnects 820, which may represent any type of interface, input/output, bus (local, system, or expansion), transmission line, trace, optical connection, etc. that allows various circuit components (on common or different chips or chipsets) to interact with one another.

The processors 802 may include processor circuitry such as, for example, baseband processor circuitry (BB) 822A, central processor unit circuitry (CPU) 822B, and graphics processor unit circuitry (GPU) 822C. The processors 802 may include any type of circuitry or processor circuitry that executes or otherwise operates computer-executable instructions, such as program code, software modules, or functional processes from memory/storage 806 to cause the UE 800 to perform operations as described herein.

In some implementations, the baseband processor circuitry 822A may access a communication protocol stack 824 in the memory/storage 806 to communicate over a 3GPP compatible network. In general, the baseband processor circuitry 822A may access the communication protocol stack to: perform user plane functions at a physical (PHY) layer, medium access control (MAC) layer, radio link control (RLC) layer, packet data convergence protocol (PDCP) layer, service data adaptation protocol (SDAP) layer, and PDU layer; and perform control plane functions at a PHY layer, MAC layer, RLC layer, PDCP layer, RRC layer, and a non-access stratum layer. In some implementations, the PHY layer operations may additionally/alternatively be performed by the components of the RF interface circuitry 804. The baseband processor circuitry 822A may generate or process baseband signals or waveforms that carry information in 3GPP-compatible networks. In some implementations, the waveforms for NR may be based cyclic prefix orthogonal frequency division multiplexing (OFDM) “CP-OFDM” in the uplink or downlink, and discrete Fourier transform spread OFDM “DFT-S-OFDM” in the uplink.

The memory/storage 806 may include one or more non-transitory, computer-readable media that includes instructions (for example, communication protocol stack 824) that may be executed by one or more of the processors 802 to cause the UE 800 to perform various operations described herein. The memory/storage 806 include any type of volatile or non-volatile memory that may be distributed throughout the UE 800. In some implementations, some of the memory/storage 806 may be located on the processors 802 themselves (for example, L1 and L2 cache), while other memory/storage 806 is external to the processors 802 but accessible thereto via a memory interface. The memory/storage 806 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 804 may include transceiver circuitry and radio frequency front module (RFEM) that allows the UE 800 to communicate with other devices over a radio access network. The RF interface circuitry 804 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via antenna structure 816 and proceed to filter and amplify (with a low-noise amplifier) the signal. The signal may be provided to a receiver of the transceiver that downconverts the RF signal into a baseband signal that is provided to the baseband processor of the processors 802.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 816. In various implementations, the RF interface circuitry 804 may be configured to transmit/receive signals in a manner compatible with NR access technologies.

The antenna 816 may include antenna elements to convert electrical signals into radio waves to travel through the air and to convert received radio waves into electrical signals. The antenna elements may be arranged into one or more antenna panels. The antenna 816 may have antenna panels that are omnidirectional, directional, or a combination thereof to enable beamforming and multiple input, multiple output communications. The antenna 816 may include microstrip antennas, printed antennas fabricated on the surface of one or more printed circuit boards, patch antennas, phased array antennas, etc. The antenna 816 may have one or more panels designed for specific frequency bands including bands in FR1 or FR2.

The user interface 808 includes various input/output (I/O) devices designed to enable user interaction with the UE 800. The user interface 808 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes “LEDs” and multi-character visual outputs), or more complex outputs such as display devices or touchscreens (for example, liquid crystal displays “LCDs,” LED displays, quantum dot displays, projectors, etc.), with the output of characters, graphics, multimedia objects, and the like being generated or produced from the operation of the UE 800.

The sensors 810 may include devices, modules, or subsystems whose purpose is to detect events or changes in its environment and send the information (sensor data) about the detected events to some other device, module, subsystem, etc. Examples of such sensors include, inter alia, inertia measurement units including accelerometers, gyroscopes, or magnetometers; microelectromechanical systems or nanoelectromechanical systems including 3-axis accelerometers, 3-axis gyroscopes, or magnetometers; level sensors; temperature sensors (for example, thermistors); pressure sensors; image capture devices (for example, cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 812 may include software and hardware elements that operate to control particular devices that are embedded in the UE 800, attached to the UE 800, or otherwise communicatively coupled with the UE 800. The driver circuitry 812 may include individual drivers allowing other components to interact with or control various input/output (I/O) devices that may be present within, or connected to, the UE 800. For example, driver circuitry 812 may include a display driver to control and allow access to a display device, a touchscreen driver to control and allow access to a touchscreen interface, sensor drivers to obtain sensor readings of sensor circuitry 810 and control and allow access to sensor circuitry 810, drivers to obtain actuator positions of electro-mechanic components or control and allow access to the electro-mechanic components, a camera driver to control and allow access to an embedded image capture device, audio drivers to control and allow access to one or more audio devices.

The PMIC 814 may manage power provided to various components of the UE 800. In particular, with respect to the processors 802, the PMIC 814 may control power-source selection, voltage scaling, battery charging, or DC-to-DC conversion.

In some implementations, the PMIC 814 may control, or otherwise be part of, various power saving mechanisms of the UE 800. A battery 818 may power the UE 800, although in some examples the UE 800 may be mounted deployed in a fixed location, and may have a power supply coupled to an electrical grid. The battery 818 may be a lithium ion battery, a metal-air battery, such as a zinc-air battery, an aluminum-air battery, a lithium-air battery, and the like. In some implementations, such as in vehicle-based applications, the battery 818 may be a typical lead-acid automotive battery.

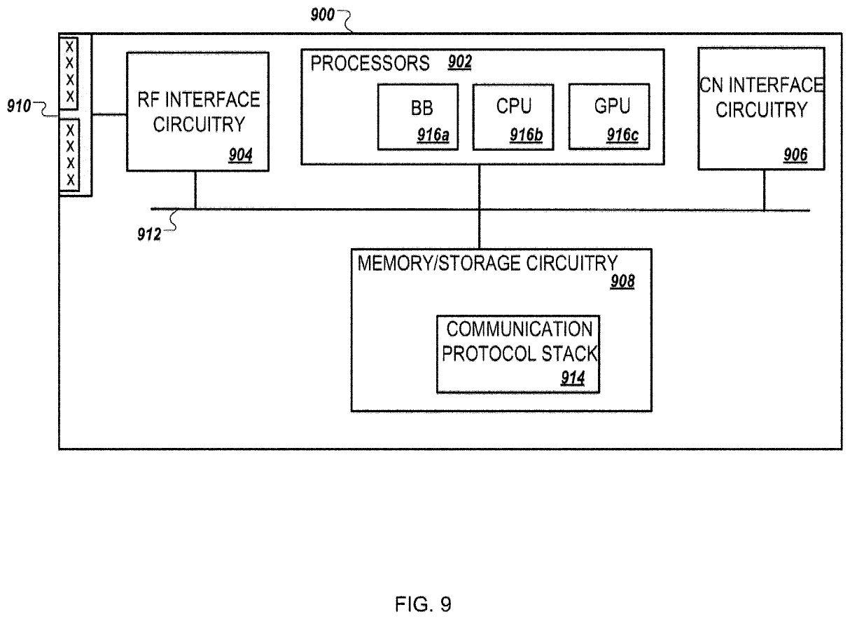

FIG. 9 illustrates an access node 900 (e.g., a base station or gNB), according to some implementations. The access node 900 may be similar to and substantially interchangeable with base station 104. The access node 900 may include processors 902, RF interface circuitry 904, core network (CN) interface circuitry 906, memory/storage circuitry 908, and antenna structure 910.

The components of the access node 900 may be coupled with various other components over one or more interconnects 912. The processors 902, RF interface circuitry 904, memory/storage circuitry 908 (including communication protocol stack 914), antenna structure 910, and interconnects 912 may be similar to like-named elements shown and described with respect to FIG. 8. For example, the processors 902 may include processor circuitry such as, for example, baseband processor circuitry (BB) 916A, central processor unit circuitry (CPU) 916B, and graphics processor unit circuitry (GPU) 916C.

The CN interface circuitry 906 may provide connectivity to a core network, for example, a 5th Generation Core network (5GC) using a 5GC-compatible network interface protocol such as carrier Ethernet protocols, or some other suitable protocol. Network connectivity may be provided to/from the access node 900 via a fiber optic or wireless backhaul. The CN interface circuitry 906 may include one or more dedicated processors or FPGAs to communicate using one or more of the aforementioned protocols. In some implementations, the CN interface circuitry 906 may include multiple controllers to provide connectivity to other networks using the same or different protocols.

As used herein, the terms “access node,” “access point,” or the like may describe equipment that provides the radio baseband functions for data and/or voice connectivity between a network and one or more users. These access nodes can be referred to as BS, gNBs, RAN nodes, eNBs, NodeBs, RSUs, TRxPs or TRPs, and so forth, and can include ground stations (e.g., terrestrial access points) or satellite stations providing coverage within a geographic area (e.g., a cell). As used herein, the term “NG RAN node” or the like may refer to an access node 900 that operates in an NR or 5G system (for example, a gNB), and the term “E-UTRAN node” or the like may refer to an access node 900 that operates in an LTE or 4G system (e.g., an eNB). According to various implementations, the access node 900 may be implemented as one or more of a dedicated physical device such as a macrocell base station, and/or a low power (LP) base station for providing femtocells, picocells or other like cells having smaller coverage areas, smaller user capacity, or higher bandwidth compared to macrocells.

In some implementations, all or parts of the access node 900 may be implemented as one or more software entities running on server computers as part of a virtual network, which may be referred to as a CRAN and/or a virtual baseband unit pool (vBBUP). In V2X scenarios, the access node 900 may be or act as a “Road Side Unit.” The term “Road Side Unit” or “RSU” may refer to any transportation infrastructure entity used for V2X communications. An RSU may be implemented in or by a suitable RAN node or a stationary (or relatively stationary) UE, where an RSU implemented in or by a UE may be referred to as a “UE-type RSU,” an RSU implemented in or by an eNB may be referred to as an “eNB-type RSU,” an RSU implemented in or by a gNB may be referred to as a “gNB-type RSU,” and the like.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112(f) interpretation for that component.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

As described above, one aspect of the present technology may relate to the gathering and use of data available from specific and legitimate sources to allow for interaction with a second device for a data transfer. The present disclosure contemplates that in some instances, this gathered data may include personal information data that uniquely identifies or can be used to identify a specific person. Such personal information data can include demographic data, location-based data, online identifiers, telephone numbers, email addresses, home addresses, data or records relating to a user's health or level of fitness (e.g., vital signs measurements, medication information, exercise information), date of birth, or any other personal information.

The present disclosure recognizes that the use of such personal information data, in the present technology, can be used to the benefit of users. For example, the personal information data can be used to provide for secure data transfers occurring between a first device and a second device. The personal information data may further be utilized for identifying an account associated with the user from a service provider for completing a data transfer.

The present disclosure contemplates that those entities responsible for the collection, analysis, disclosure, transfer, storage, or other use of such personal information data will comply with well-established privacy policies and/or privacy practices. In particular, such entities would be expected to implement and consistently apply privacy practices that are generally recognized as meeting or exceeding industry or governmental requirements for maintaining the privacy of users. Such information regarding the use of personal data should be prominent and easily accessible by users, and should be updated as the collection and/or use of data changes. Personal information from users should be collected for legitimate uses only. Further, such collection/sharing should occur only after receiving the consent of the users or other legitimate basis specified in applicable law. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations that may serve to impose a higher standard. For instance, in the US, collection of or access to certain health data may be governed by federal and/or state laws, such as the Health Insurance Portability and Accountability Act (HIPAA); whereas health data in other countries may be subject to other regulations and policies and should be handled accordingly.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, the present technology can be configured to allow users to select to “opt in” or “opt out” of participation in the collection of personal information data during registration for services or anytime thereafter. For example, a user may “opt in” or “opt out” of having information associated with an account of the user stored on a user device and/or shared by the user device. In addition to providing “opt in” and “opt out” options, the present disclosure contemplates providing notifications relating to the access or use of personal information. For instance, a user may be notified upon downloading an application that their personal information data will be accessed and then reminded again just before personal information data is accessed by the application. In some instances, the user may be notified upon initiation of a data transfer of the device accessing information associated with the account of the user and/or the sharing of information associated with the account of the user with another device.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing identifiers, controlling the amount or specificity of data stored (e.g., collecting location data at city level rather than at an address level), controlling how data is stored (e.g., aggregating data across users), and/or other methods such as differential privacy.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users based on aggregated non-personal information data or a bare minimum amount of personal information, such as the content being handled only on the user's device or other non-personal information available to the content delivery services.

1-54. (canceled)

55. A method, comprising:
receiving a first resource configuration for a small data transmission (SDT) to a base station;
performing timing advance (TA) validation for the SDT during a first paging time window (PTW); and
determining whether to transmit the SDT using the first resource based on a result of the TA validation.

56. The method of claim 55, wherein performing the TA validation comprises:
performing at least one reference signal received power (RSRP) measurement during the first PTW; and
determining whether the at least one RSRP measurement satisfies a time threshold.

57. The method of claim 56, wherein the at least one RSRP measurement comprises a first RSRP measurement and a second RSRP measurement.

58. The method of claim 56, further comprising:
determining that the at least one RSRP measurement satisfies the time threshold; and
transmitting the SDT using the first resource in response to determining that the at least one RSRP measurement satisfies the time threshold.

59. The method of claim 56, further comprising:
determining that the at least one RSRP measurement does not satisfy the time threshold; and
withholding transmission of the SDT using the first resource in response to determining that the at least one RSRP measurement does not satisfy the time threshold.

60. The method of claim 55, wherein the first resource is in the first PTW.

61. The method of claim 55, further comprising:
reperforming the TA validation in a second PTW that is different from the first PTW, wherein reperforming the TA validation comprises reperforming at least one reference signal received power (RSRP) measurement during the second PTW;
determining whether the reperformed at least one RSRP measurement satisfies a time threshold; and
transmitting the SDT using a second resource in the second PTW in response to determining that the reperformed at least one RSRP measurements satisfies the time threshold.

62. The method of claim 55, further comprising:
performing a first reference signal received power (RSRP) measurement in the first PTW;
reperforming the first RSRP measurement in a second PTW that is different from the first PTW;
performing a second RSRP measurement in the second PTW; and
performing timing advance (TA) validation based on the reperformed first RSRP measurement and the second RSRP measurement.

63. The method of claim 55, wherein the method is performed by a reduced capability user equipment (RedCap UE) in a radio resource control inactive (RRC_INACTIVE) state.

64. The method of claim 55, wherein the first PTW is in an extended discontinuous reception (eDRX) cycle.

65. The method of claim 64, wherein the eDRX cycle is greater than 10.24 seconds.

66. One or more baseband processors configured, when executing instructions stored in memory, to perform operations comprising:
receiving a first resource configuration for a small data transmission (SDT) to a base station;
performing timing advance (TA) validation for the SDT during a first paging time window (PTW); and
determining whether to transmit the SDT using the first resource based on a result of the TA validation.

67. The one or more baseband processors of claim 66, wherein performing the TA validation comprises:
performing at least one reference signal received power (RSRP) measurement during the first PTW; and
determining whether the at least one RSRP measurement satisfies a time threshold.

68. The one or more baseband processors of claim 67 configured, when executing instructions stored in memory, to perform operations comprising:
determining that the at least one RSRP measurement satisfies the time threshold; and
transmitting the SDT using the first resource in response to determining that the at least one RSRP measurement satisfies the time threshold.

69. The one or more baseband processors of claim 67 configured, when executing instructions stored in memory, to perform operations comprising:
determining that the at least one RSRP measurement does not satisfy the time threshold; and
withholding transmission of the SDT using the first resource in response to determining that the at least one RSRP measurement does not satisfy the time threshold.

70. The one or more baseband processors of claim 66, wherein the first PTW is in an extended discontinuous reception (eDRX) cycle, and wherein the eDRX cycle is greater than 10.24 seconds.

71. A user equipment (UE), comprising:
one or more processors; and
memory storing instructions which, when executed by the one or more processors, cause the UE to perform operations comprising:
receiving a first resource configuration for a small data transmission (SDT) to a base station;
performing timing advance (TA) validation for the SDT during a first paging time window (PTW); and
determining whether to transmit the SDT using the first resource based on a result of the TA validation.

72. The UE of claim 71, wherein performing the TA validation comprises:
performing at least one reference signal received power (RSRP) measurement during the first PTW; and
determining whether the at least one RSRP measurement satisfies a time threshold.

73. The UE of claim 72, the memory storing instructions which, when executed by the one or more processors, cause the UE to perform operations comprising:
determining that the at least one RSRP measurement satisfies the time threshold; and
transmitting the SDT using the first resource in response to determining that the at least one RSRP measurement satisfies the time threshold.

74. The UE of claim 72, the memory storing instructions which, when executed by the one or more processors, cause the UE to perform operations comprising:
determining that the at least one RSRP measurement does not satisfy the time threshold; and
withholding transmission of the SDT using the first resource in response to determining that the at least one RSRP measurement does not satisfy the time threshold.
